(19) United States
(12) Patent Application Publication
(10) Pub. No.: US 2026/0263197 A1
(43) Pub. Date: Sep. 10, 2026

(54) Dental Bridge Device

(71) Applicant: Denise Wilson, Waterford, NY (US)

(72) Inventor: Denise Wilson, Waterford, NY (US)

(21) Appl. No.: 19/096,235

(22) Filed: Mar. 31, 2025

Related U.S. Application Data
(60) Provisional application No. 63/768,230, filed on Mar. 7, 2025.

(51) Int. Cl. A61C 13/271; A61C 13/01; A61C 13/08

(52) U.S. Cl. CPC A61C 13/26; A61C 13/01; A61C 13/082

(57) ABSTRACT

A dental bridge device is provided. The device is comprised of a dental bridge device designed to enhance safety, comfort, and usability compared to existing dental bridges. The device comprises a false gum base with rounded edges to prevent irritation and may incorporate a textured or gel-infused lining for improved adhesion and comfort. At least one false tooth is integrated into the gum base, with an exterior glaze or polished finish for resistance to plaque and staining. Multiple gum bases can be connected via a reinforced metal or composite connecting member to distribute biting pressure evenly. The device further comprises at least one attachment member designed with curved jaws that securely grip abutment teeth. The jaws are comprised of protective, rounded ends that ensure comfort and safety by preventing irritation and injuries.

### CROSS-REFERENCE TO RELATED APPLICATION

The present application claims priority to, and the benefit of, U.S. Provisional Application No. 63/768,230, which was filed on Mar. 7, 2025, and is incorporated herein by reference in its entirety.

### FIELD OF THE INVENTION

The present invention relates generally to the field of dental bridges. More specifically, the present invention relates to an improved dental bridge that is comprised of a false gum base with rounded edges, at least one false tooth, and at least one attachment member with curved jaws and protective rounded ends to ensure a secure, comfortable fit without irritation or injury. Accordingly, the present disclosure makes specific reference thereto. Nonetheless, it is to be appreciated that aspects of the present invention are also equally applicable to other like applications, devices, and methods of manufacture.

### BACKGROUND

Traditional dental bridges are widely used to restore function and aesthetics for individuals with missing teeth. However, many users experience significant discomfort and potential injury due to the sharp edges and rigid structure of conventional bridge appliances. When inserting or removing the bridge, sharp points or improperly contoured surfaces can cause pokes, scratches, and irritation to the gums and surrounding oral tissues. This issue is particularly concerning for individuals with sensitive gums or pre-existing oral conditions, as repeated irritation can lead to inflammation or infection. Furthermore, traditional dental bridges often rely on rigid attachment mechanisms that exert excessive pressure on abutment teeth, contributing to discomfort and, in some cases, damage to natural teeth. The lack of adaptability in traditional bridge materials can also result in a poor fit, leading to instability and movement during use, which further exacerbates user discomfort. Due to these drawbacks, individuals may struggle with consistent wear, leading to inadequate dental function and reduced confidence in their prosthetic solution.

Therefore, there exists a long-felt need in the art for an improved dental bridge device that eliminates pokes and scratches to the wearer. There also exists a long-felt need in the art for an improved dental bridge device that provides a secure yet comfortable fit without exerting excessive pressure on surrounding teeth. Moreover, there exists a long-felt need in the art for an improved dental bridge device that incorporates adaptive and ergonomic materials to enhance overall usability and long-term wearability.

The subject matter disclosed and claimed herein, in one embodiment thereof, comprises a dental bridge device. The device is comprised of a dental bridge device designed to enhance safety, comfort, and usability compared to existing dental bridges. The device comprises a false gum base with rounded edges to prevent irritation and may incorporate a textured or gel-infused lining for improved adhesion and comfort. At least one false tooth is integrated into the gum base, with an exterior glaze or polished finish for resistance to plaque and staining. Multiple gum bases can be connected via a reinforced metal or composite connecting member to distribute biting pressure evenly. The device further comprises at least one attachment member designed with curved jaws that securely grip abutment teeth. The jaws are comprised of protective, rounded ends that ensure comfort and safety by preventing irritation and injuries.

In this manner, the dental bridge device of the present invention accomplishes all the foregoing objectives and provides an improved dental bridge that enhances safety, comfort, and usability. More specifically, the false gum base constructed from flexible and biocompatible materials ensures a secure and comfortable fit while minimizing irritation. The inclusion of rounded edges and protective end caps on the attachment members eliminates sharp points, preventing injury to the gums and surrounding tissues. As a result, the device provides a safer, more comfortable, and user-friendly alternative to conventional dental bridges.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a dental bridge device. The dental bridge device is a prosthetic designed to enhance safety, comfort, and usability compared to traditional dental bridges by minimizing the risk of oral tissue damage while improving overall wearability.

The device is comprised of a false gum base that provides structural support and ensures a secure, comfortable fit against the gums. The gum base may have rounded edges to help prevent irritation, while a textured or specially lined interior surface improves adhesion and enhances comfort. In some variations, the gum base is made from a temperature-adaptive material that softens at body temperature for an adaptive fit.

The false gum base is comprised of at least one false tooth that restores function and appearance. The false tooth may be made from ceramic, zirconia, composite resin, or high-strength polymer for durability. A glazed or polished exterior surface resists plaque accumulation and staining.

In embodiments with multiple false gum bases, at least one connecting member links the bases to distribute biting pressure evenly. The connecting member may be curved to further optimize pressure distribution.

The device is also comprised of at least one attachment member that secures the bridge to a user’s existing teeth. The attachment member may be affixed to the false gum base, false tooth, or connecting member and is designed with curved jaws to provide a stable fit while minimizing excessive pressure. A protective end at the tip of the attachment member enhances safety and comfort. More specifically, the protective end is preferably spherical or rounded to eliminate sharp edges that could cause irritation or injury. The end may be made from soft silicone, biocompatible resin, or smooth ceramic beads, ensuring a gentle interface with oral tissues while preventing discomfort from minor bridge movements.

The invention also includes a method of using the device. First, the device is positioned in the user’s mouth by aligning the false gum base with the gums and ensuring proper alignment of the false tooth with adjacent teeth. The attachment member is then engaged with the user’s abutment teeth by applying gentle pressure to secure the curved jaws. During use, the device remains stable while accommodating natural oral movements, with the temperature-adaptive material conforming to the gums for improved comfort. Removal of the device involves disengaging the attachment member and lifting the device in a controlled manner to avoid accidental slipping or damage to oral tissues.

Accordingly, the dental bridge device of the present invention is particularly advantageous as it provides an improved dental bridge that enhances safety, comfort, and usability. More specifically, the false gum base constructed from flexible and biocompatible materials ensures a secure and comfortable fit while minimizing irritation. The inclusion of rounded edges and protective end caps on the attachment members eliminates sharp points, preventing injury to the gums and surrounding tissues. As a result, the device provides a safer, more comfortable, and user-friendly alternative to conventional dental bridges known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a dental bridge device of the present invention while detached from a user’s bottom jaw in accordance with the disclosed architecture;

FIG. 2 illustrates a perspective view of one potential embodiment of a dental bridge device of the present invention while attached to a user’s bottom jaw and existing teeth in accordance with the disclosed architecture; and

FIG. 3 illustrates a flowchart of a method of using one potential embodiment of a dental bridge device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved dental bridge device that eliminates pokes and scratches to the wearer. There also exists a long-felt need in the art for an improved dental bridge device that provides a secure yet comfortable fit without exerting excessive pressure on surrounding teeth. Moreover, there exists a long-felt need in the art for an improved dental bridge device that incorporates adaptive and ergonomic materials to enhance overall usability and long-term wearability.

The present invention, in one exemplary embodiment, is comprised of a dental bridge device. The dental bridge device is a prosthetic designed to improve safety, comfort, and usability over traditional dental bridges by reducing the risk of oral tissue damage and enhancing overall wearability.

The device is comprised of a false gum base that provides structural support while ensuring a secure and comfortable fit against the gums. The gum base may feature rounded edges to minimize irritation, while a textured or specially lined interior surface enhances adhesion and comfort. In some variations, the gum base is made from a temperature-adaptive material that softens at body temperature to create a more adaptive fit.

The false gum base is comprised of at least one false tooth that restores function and appearance. The false tooth may be made from ceramic, zirconia, composite resin, or high-strength polymer for durability. A glazed or polished exterior surface resists plaque buildup and staining.

In embodiments with multiple false gum bases, at least one connecting member links the bases to distribute biting pressure evenly. A curved structure in the connecting member may further optimize pressure distribution.

The device is also comprised of at least one attachment member that secures the bridge to the user’s existing teeth. The attachment member may be affixed to the false gum base, false tooth, or connecting member and is designed with curved jaws to ensure a stable fit while minimizing excessive pressure. A protective end at the tip of the attachment member improves safety and comfort. This protective end is preferably spherical or rounded to eliminate sharp edges that could cause irritation or injury. It may be made from soft silicone, biocompatible resin, or smooth ceramic beads to provide a gentle interface with oral tissues while preventing discomfort from minor bridge movements.

The invention also includes a method of use. First, the device is positioned in the user’s mouth by aligning the false gum base with the gums and ensuring proper positioning of the false tooth relative to adjacent teeth. The attachment member is then engaged with the user’s abutment teeth by applying gentle pressure to secure the curved jaws. During use, the device remains stable while accommodating natural oral movements, with the temperature-adaptive material conforming to the gums for enhanced comfort. To remove the device, the attachment member is disengaged, and the device is lifted in a controlled manner to prevent accidental slipping or damage to oral tissues.

As a result, the dental bridge device provides an improved alternative to conventional dental bridges by enhancing safety, comfort, and usability. The false gum base, constructed from flexible and biocompatible materials, ensures a secure and comfortable fit while minimizing irritation. The inclusion of rounded edges and protective end caps on the attachment members eliminates sharp points, reducing the risk of injury to the gums and surrounding tissues. Therefore, the device offers a safer, more comfortable, and user-friendly solution compared to existing dental bridges.

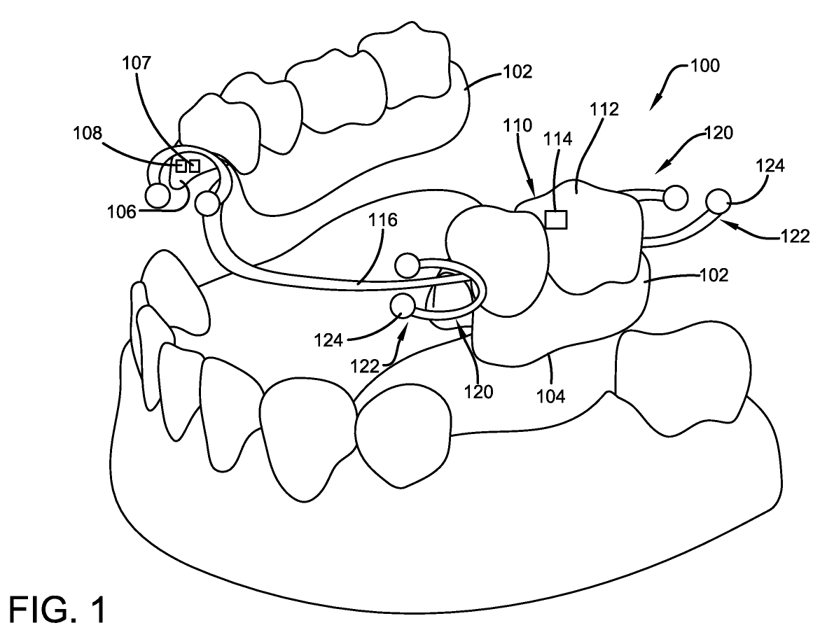

Referring initially to the drawings, FIG. 1 illustrates a perspective view of one potential embodiment of a dental bridge device 100 of the present invention while detached from a user’s bottom jaw in accordance with the disclosed architecture. The dental bridge device 100 is a dental prosthetic designed to improve safety, comfort, and usability compared to traditional dental bridges. The device 100 reduces the risk of oral tissue damage and enhances overall wearability by integrating advanced materials and an ergonomic structure.

The dental bridge device 100 is comprised of a false gum base 102, which provides structural support while ensuring a secure and comfortable fit against the gums. The false gum base 102 may be made from high-quality acrylic resin, flexible polymer, or a silicone-based material that closely resembles natural gum tissue. To enhance user comfort, the edges 104 of the false gum base 102 may be rounded to prevent irritation. In one embodiment, the interior surface 106 of the gum base 102 includes a textured surface 108 to improve adhesion and minimize slipping during wear. In a further embodiment, the interior surface 106 incorporates a specialized lining 107, such as a gel-infused or silicone-based layer, to enhance comfort for patients with sensitive gums. In another variation, the gum base 102 is constructed from a temperature-adaptive material that softens slightly at body temperature to allow for a more adaptive fit while remaining strong at cooler temperatures.

The gum base 102 is comprised of at least one false tooth 110, which restores function and appearance. The false tooth 110 may be made from materials such as ceramic, zirconia, composite resin, or high-strength polymer to provide long-lasting performance. In one embodiment, the exterior surface 112 of the false tooth 110 is comprised of a glaze 114 or polished finish to resist plaque accumulation and staining.

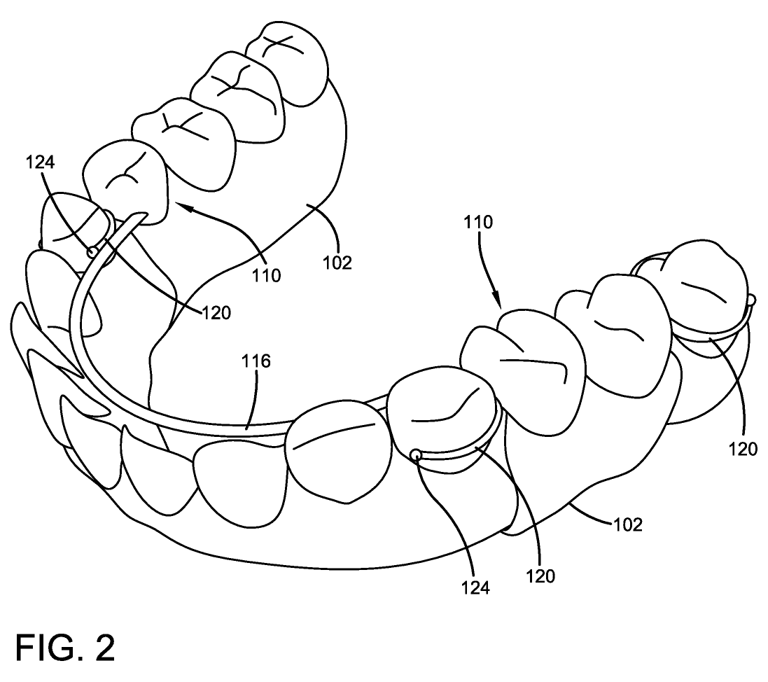

In an embodiment where the dental bridge device 100 is comprised of multiple false gum bases 102, the bases 102 may be connected via at least one connecting member 116 to evenly distribute biting pressure and prevent excessive force on individual false teeth 110, as seen in FIG. 1 and FIG. 2. The connecting member 116 may be constructed from a reinforced metal alloy, titanium, or fiber-reinforced composite to ensure strength and durability while remaining lightweight to minimize strain on adjacent teeth. The connecting member 116 may also feature an ergonomically curved structure for improved comfort and optimized pressure distribution.

The dental bridge device 100 is also comprised of at least one attachment member 120, which facilitates secure engagement with a user’s existing teeth, as seen in FIG. 2. In various embodiments, the attachment member 120 may be affixed to the false gum base 102, the false tooth 110, or the connecting member 116. The attachment member 120 is preferably designed with a pair of curved jaws that securely grip the abutment teeth, ensuring a stable fit while reducing excessive pressure. These members 120 may be constructed from biocompatible stainless steel, titanium, or ceramic-coated materials to provide durability and resistance to corrosion.

A tip 122 of the attachment member 120 is comprised of at least one protective end 124 to enhance safety and comfort. The protective end 124 is preferably spherical or rounded, eliminating sharp edges that could cause irritation or injury. The protective end 124 may be made from a soft silicone cap, biocompatible resin, or smooth ceramic beads to create a comfortable interface with oral tissues. By preventing injuries and reducing discomfort caused by minor bridge movement during chewing or speaking, the protective ends 124 contribute to a more comfortable user experience.

As a result, the dental bridge device 100 offers several advantages over traditional dental bridges. The elimination of sharp edges prevents injury and irritation while ensuring stability without excessive pressure or discomfort. The design further allows for easy insertion and removal without the risk of accidental injury. By integrating an adaptive false gum base 102, durable false teeth 110, an ergonomic connecting member 116, and a more gentle attachment system 120, the dental bridge device 100 provides a patient-friendly alternative to existing dental bridges.

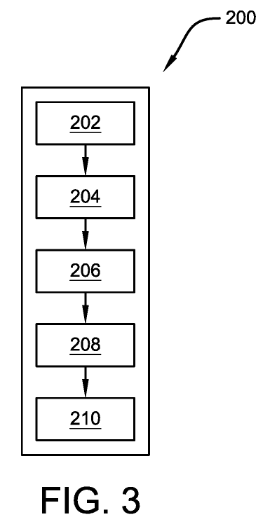

The present invention is also comprised of a method of using 200 the dental bridge device 100, as seen in FIG. 3. First, a dental bridge device 100 is provided, comprising a false gum base 102, at least one false tooth 110, at least one attachment member 120, and, in certain embodiments, at least one connecting member 116 [Step 202]. Next, the dental bridge device 100 is positioned in the user's mouth by aligning the false gum base 102 with the gums and ensuring that the false tooth 110 is in proper alignment with adjacent teeth [Step 206]. The attachment member 120 is then engaged with the user’s existing abutment teeth, wherein the user applies gentle pressure to secure the curved jaws of the attachment member 120 onto the abutment teeth [Step 208]. During use, the dental bridge device 100 remains in place while accommodating natural oral movements. The temperature-adaptive material of the false gum base 102 conforms to the gums for improved comfort. To remove the dental bridge device 100, the user applies gentle pressure to disengage the attachment member 120 from the abutment teeth and lifts the device 100 away from the gums in a controlled manner to prevent accidental slipping or damage to oral tissues [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein, “dental bridge device” and “device” are interchangeable and refer to the dental bridge device 100 of the present invention.

Notwithstanding the foregoing, the dental bridge device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the dental bridge device 100 as shown in the FIGS. are for illustrative purposes only, and that many other sizes and shapes of the dental bridge device 100 are well within the scope of the present disclosure. Although the dimensions of the dental bridge device 100 are important design parameters for user convenience, the dental bridge device 100 may be of any size, shape, and/or configuration that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A dental bridge device comprising:
a false gum base;
a false tooth coupled to the false gum base; and
an attachment member comprised of a first jaw comprised of a first protective end and a second jaw comprised of a second protective end.

2. The dental bridge device of claim 1, wherein the false gum base is comprised of a rounded edge.

3. The dental bridge device of claim 1, wherein the false gum base is comprised of a temperature-adaptive material.

4. The dental bridge device of claim 1, wherein the false tooth is comprised of a glaze.

5. The dental bridge device of claim 1, wherein the false gum base is comprised of a polished finish.

6. The dental bridge device of claim 1, wherein the first protective end and the second protective end are rounded or spherical.

7. The dental bridge device of claim 1, wherein the first protective end and the second protective end are comprised of a silicone, a resin, or a smooth ceramic bead.

8. The dental bridge device of claim 1, wherein the false gum base is comprised of a flexible material.

9. The dental bridge device of claim 1, wherein an interior surface of the first false gum base is textured.

10. A dental bridge device comprising:
a first false gum base comprised of a first false tooth coupled to the first false gum base;
a second false gum base comprised of a second false tooth coupled to the second false gum base;
a connecting member that attaches the first false gum base to the second false gum base or the first false tooth to the second false tooth; and
a first attachment member comprised of a first jaw comprised of a first protective end and a second jaw comprised of a second protective end.

11. The dental bridge device of claim 10, wherein the connecting member is curved.

12. The dental bridge device of claim 10, wherein the first false gum base is comprised of a rounded edge.

13. The dental bridge device of claim 10, wherein the first false gum base is comprised of a temperature-adaptive material.

14. The dental bridge device of claim 10, wherein the first false tooth is comprised of a glaze.

15. The dental bridge device of claim 10, wherein the first false gum base is comprised of a polished finish.

16. The dental bridge device of claim 10, wherein the first protective end and the second protective end are rounded or spherical.

17. The dental bridge device of claim 10, wherein the first protective end and the second protective end are comprised of a silicone, a resin, or a smooth ceramic bead.

18. The dental bridge device of claim 10, wherein the first false gum base is comprised of a flexible material.

19. The dental bridge device of claim 10, wherein an interior surface of the first false gum base is textured.

20. A method of using a dental bridge device, the method comprising: the following steps
providing a dental bridge device comprised of a false gum base, a false tooth coupled to the false gum base, and an attachment member comprised of a protective end;
positioning the dental bridge device in a user’s mouth by aligning the false gum base with a user’s gums;
engaging the attachment member with an abutment tooth by applying pressure to secure the attachment member onto the abutment tooth; and
removing the dental bridge device by applying pressure to disengage the attachment member and lifting the dental bridge device away from the gums in a controlled manner.
